(19) United States
(12) Patent Application Publication
(10) Pub. No.: US 2012/0013714 A1
(43) Pub. Date: Jan. 19, 2012

(54) DISTANCE MEASURING METHOD AND DISTANCE MEASURING APPARATUS

(76) Inventor: Tomonori Masuda, Miyagi (JP)

(21) Appl. No.: 13/260,296

(22) PCT Filed: Mar. 19, 2010
(86) PCT No.: PCT/JP2010/001992

§ 371 Date: Sep. 24, 2011

(30) Foreign Application Priority Data
Mar. 25, 2009 (JP) 2009-073555

(51) Int. Cl. H04N 13/02

(52) U.S. Cl. 348/47; 348/E13.074

(57) ABSTRACT

Large errors are prevented from being generated in a distance measuring method that employs two imaging means. The distance measuring method includes the steps of: photographing a subject using two imaging means, which are provided with a predetermined baseline length therebetween; and obtaining distance data regarding corresponding points within the photographed pairs of images. A first photography operation is performed with the baseline length at a desired value. Then, n photography operations are performed, while varying the baseline length by L(m+1/n), L(m+2/n) . . . L(m+(n−1)/n) at each photography operation, wherein L is a pixel pitch of the imaging means, m is an arbitrary natural number, and n is an integer greater than or equal to 2. Amounts of parallax within a predetermined range common to each photography operation are extracted by a record judging section, from among the amounts of parallax which are obtained by a parallax calculating section for the n photography operations. The distance data is obtained based on the extracted amounts of parallax.

### TECHNICAL FIELD

The present invention is related to a method that obtains pairs of images having parallax by photographing a subject with two imaging means, and measures the distances of points within the images based on the images.

The present invention is also related to an apparatus for executing the aforementioned distance measuring method.

### BACKGROUND ART

There are known methods, in which a subject is photographed by two imaging means provided with a predetermined baseline length therebetween to obtain two images having parallax, and the distances of points within the images are measured based on the images, as disclosed in Japanese Unexamined Patent Publication No. 2000-283753, for example. This type of distance measuring method is utilized to generate stereoscopic images, and to obtain three dimensional positional data of objects which are the targets of measurement.

However, there are cases in which large errors are generated in the distance data, which are calculated based on amounts of parallax, within a specific range of amounts of parallax within the photographed subject, in the conventional distance measuring methods that employ two imaging means, as described above.

Japanese Unexamined Patent Publication No. 8(1996)-075456 discloses an invention, in which a pair of imaging means are moved slightly, to correct distance data based on shifting of feature points (amounts of movement in units of sub pixels), in order to improve the accuracy of measured distance data. However, this correction is troublesome, and the correcting process is time consuming.

The present invention has been developed in view of the foregoing circumstances. It is an object of the present invention to provide a distance measuring method that employs two imaging means, which is capable of preventing large errors from being generated in a simple manner.

It is another object of the present invention to provide a distance measuring apparatus that can execute the distance measuring method.

### DISCLOSURE OF THE INVENTION

A distance measuring method of the present invention is a distance measuring method, for obtaining distance data regarding corresponding points within pairs of images of a subject, which have been obtained by photographing the subject with two imaging means provided with a predetermined baseline length therebetween, based on the amounts of parallax among the corresponding points, characterized by:

a first photography operation being performed with the baseline length at a desired value;

n photography operations being performed after the first photography operation, while varying the baseline length by L(m+1/n), L(m+2/n) . . . L(m+(n−1)/n) at each photography operation, wherein L is a pixel pitch of the imaging means, m is an arbitrary natural number, and n is an integer greater than or equal to 2;

amounts of parallax within a predetermined range common to each photography operation being extracted from among the amounts of parallax which are obtained by the n photography operations; and

the distance data being obtained based on the extracted amounts of parallax.

Note that a technique, in which three or more images having parallax are photographed and distance data is obtained based on corresponding points within these images, is known. In this case as well, if each of the processes described above are administered with respect to pairs of images from among the three or more images, such a method is included in the scope of the present invention.

In the distance measuring method of the present invention, it is desirable for one of the imaging means to be fixed when varying the baseline length. The variations of the baseline length may be decreases or increases in the baseline length.

In the distance measuring method of the present invention, it is also desirable for the extracted amounts of parallax to be subject to a correcting process that compensates for variations due to the differences in baseline lengths; and for the distance data to be obtained based on the processed amounts of parallax.

In the distance measuring method of the present invention, it is further desirable for the value of n to be changed according to one of a desired distance output accuracy and a desired distance output speed.

Meanwhile, a distance measuring apparatus of the present invention comprises:

two imaging means, which are provided with a predetermined baseline length therebetween; and

calculating means, for obtaining distance data regarding corresponding points within pairs of images of a subject, which have been obtained by photographing the subject with the two imaging means, based on the amounts of parallax among the corresponding points; characterized by further comprising:

moving means, for relatively moving the two imaging means so as to perform n photography operations while varying the baseline length by L(m+1/n), L(m+2/n). . . L(m+(n−1)/n) at each photography operation, wherein L is a pixel pitch of the imaging means, m is an arbitrary natural number, and n is an integer greater than or equal to 2, after a first photography operation, during which the baseline length is set at a desired value, is performed; and

the calculating means being configured to extract amounts of parallax within a predetermined range common to each photography operation from among the amounts of parallax which are obtained by the n photography operations and to obtain the distance data based on the extracted amounts of parallax.

Here as well, the variations of the baseline length may be decreases or increases in the baseline length.

Note that in the distance measuring apparatus of the present invention, it is desirable for the moving means to move one of the imaging means, while maintaining the other imaging means in a fixed state.

It is describable for the distance measuring apparatus of the present invention to further comprise:

correcting means, for administering a correcting process that compensates for variations due to the differences in baseline lengths on the extracted amounts of parallax.

There are cases in which large errors are generated in distance data, which are calculated based on amounts of parallax, within a specific range of amounts of parallax within the photographed subject in distance measuring methods that employ two imaging means. The range of amounts of parallax at which these large errors are generated appear periodically at periods corresponding to the pixel pitches of the imaging means.

The distance measuring method of the present invention was developed in view of the foregoing fact. That is, a first photography operation is performed with the baseline length set at an arbitrary value. Thereafter, n photography operations are performed, while varying the baseline length by L(m+1/n), L(m+2/n) . . . L(m+(n−1)/n) at each photography operation, wherein L is a pixel pitch of the imaging means, m is an arbitrary natural number, and n is an integer greater than or equal to 2. Then, amounts of parallax within a predetermined range common to each photography operation are extracted from among the amounts of parallax which are obtained by the n photography operations. Finally, the distance data are obtained based on the extracted amounts of parallax. Therefore, amounts of parallax that do not result in large errors in the distance data being generated can be utilized to obtain the distance data, by setting the predetermined range appropriately.

Note that in the distance measuring method of the present invention, a configuration may be adopted, in which one of the imaging means is fixed while varying the baseline length. In this case, the origin of a three dimensional space can be correlated to the fixed imaging means. Therefore, combining of amounts of parallax and combining of distance data, to be described later, can be facilitated.

In addition, in the distance measuring method of the present invention, a configuration may be adopted, in which the extracted amounts of parallax are subject to a correcting process that compensates for variations due to the differences in baseline lengths; and the distance data are obtained based on the processed amounts of parallax. In this case, errors being generated due to the changes in baseline lengths can be prevented, and it becomes possible to obtain accurate distance data.

In the distance measuring method of the present invention, a configuration may be adopted, wherein: the value of n is changed according to one of a desired distance output accuracy and a desired distance output speed. In this case, realization of the desired distance output accuracy or the desired distance output speed can be facilitated. That is, if the value of n is increased, the number of photography operations increases. Therefore, the amount of time required until measured distances are ultimately output becomes long, and the distance output speed decreases. However, the greater the value of n is, amounts of parallax that have smaller amounts of error can be extracted and utilized, and therefore the distance output accuracy is improved. In contrast to the above, if the value of n is decreased, the distance output speed is improved, while the distance output accuracy deteriorates. Because of these trends, realization of the desired distance output accuracy or the desired distance output speed can be facilitated by setting the value of n to be large in the case that the desired distance output accuracy is high, and by setting the value of n to be small in the case that the desired distance output speed is high.

As described above, the distance measuring apparatus of the present invention comprises:

the two imaging means, which are provided with the predetermined baseline length therebetween; and

the calculating means, for obtaining distance data regarding corresponding points within pairs of images of a subject, which have been obtained by photographing the subject with the two imaging means, based on the amounts of parallax among the corresponding points; characterized by further comprising:

the moving means, for relatively moving the two imaging means so as to perform n photography operations while varying the baseline length by L(m+1/n), L(m+2/n) . . . L(m+(n−1)/n) at each photography operation, wherein L is a pixel pitch of the imaging means, m is an arbitrary natural number, and n is an integer greater than or equal to 2, after a first photography operation, during which the baseline length is set at a desired value, is performed; and

the calculating means being configured to extract amounts of parallax within a predetermined range common to each photography operation from among the amounts of parallax which are obtained by the n photography operations and to obtain the distance data based on the extracted amounts of parallax. Therefore, the distance measuring apparatus of the present invention is capable of executing the distance measuring method of the present invention.

A configuration may be adopted, wherein the distance measuring apparatus of the present invention further comprises: the correcting means, for administering a correcting process that compensates for variations due to the differences in baseline lengths on the extracted amounts of parallax. In this case, errors being generated due to the changes in baseline lengths can be prevented, and it becomes possible to obtain accurate distance data.

### BRIEF DESCRIPTION OF THE DRAWINGS

FIG. 1 is a side view that illustrates the entire structure of a distance measuring apparatus according to a first embodiment of the present invention.

FIG. 2 is a block diagram that illustrates the main parts of the apparatus of FIG. 1.

FIG. 3 is a flow chart that illustrates the steps of a process performed by the apparatus of FIG. 1.

FIG. 4 is a collection of diagrams that illustrate the relationships among amounts of parallax and errors, and for explaining amounts of parallax to be extracted.

FIG. 5 is a collection of diagrams that illustrate an example of parallax properties, and for explaining amounts of parallax to be extracted.

FIG. 6 is a collection of diagrams that illustrate variations in amounts of parallax according to baseline lengths.

FIG. 7 is a collection of diagrams for explaining a process for correcting the variations illustrated in FIG. 6.

FIG. 8 is a block diagram that illustrates the main parts of a distance measuring apparatus according to a second embodiment of the present invention.

FIG. 9 is a flow chart that illustrates the steps of a process performed by the apparatus of FIG. 8.

FIG. 10 is a block diagram that illustrates the main parts of a distance measuring apparatus according to a third embodiment of the present invention.

FIG. 11 is a flow chart that illustrates the steps of a process performed by the apparatus of FIG. 10.

### BEST MODE FOR CARRYING OUT THE INVENTION

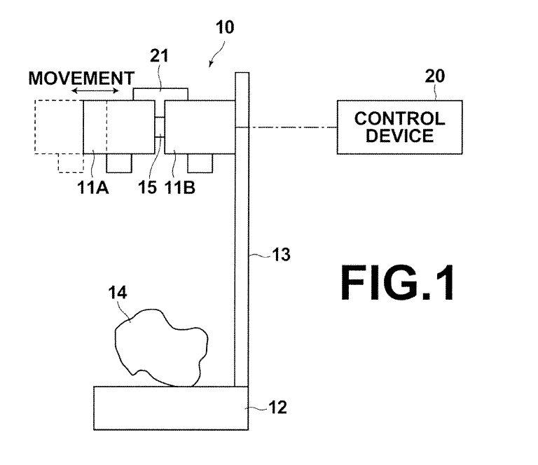

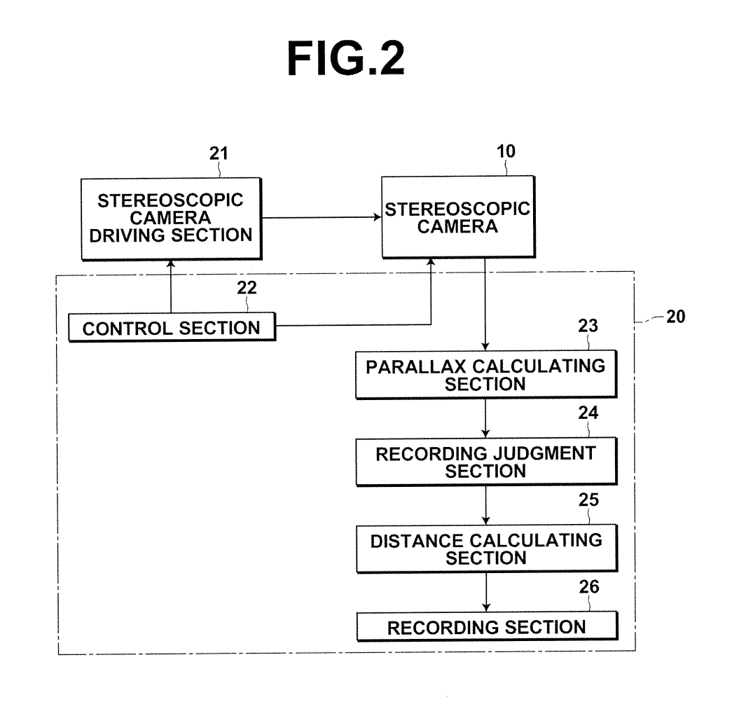

Hereinafter, embodiments of the present invention will be described with reference to the attached drawings. FIG. 1 is a side view that illustrates the entire structure of a distance measuring apparatus according to a first embodiment of the present invention. FIG. 2 is a block diagram that illustrates the configuration of a control device 20 illustrated in FIG. 1, along with a stereoscopic camera 10 and a stereoscopic camera driving section 21.

The distance measuring apparatus of the first embodiment is applied to a three dimensional measuring apparatus as an example. As illustrated in FIG. 1, the distance measuring apparatus is equipped with: the stereoscopic camera 10, which has two digital cameras 11A and 11B; a base 12; a stand 13 which is provided to extend perpendicularly from the base 12; a rail 15 that holds the digital cameras 11A and 11B such that they are movable in the horizontal direction of FIG. 1, to photograph a measurement target 14; a stereoscopic camera driving section 21 for moving the digital camera 11A along the rail 15; and a control device 20 for controlling the stereoscopic camera 10 and the stereoscopic camera driving section 21.

As illustrated in FIG. 2, the control device 20 is equipped with: a control section 22 for controlling the operations of the stereoscopic camera 10 and the stereoscopic camera driving section 21; a parallax calculating section 23 for receiving digital image data output from the digital cameras 11A and 11B; a recording judgment section 24 which is connected to the parallax calculating section 23; a distance calculating section 25 which is connected to the recording judgment section 24; and a recording section 26 which is connected to the distance calculating section 25. The control device 20 is constituted by a known computer system (not shown) that includes a calculating section, a memory section, an interface, a display means, and the like.

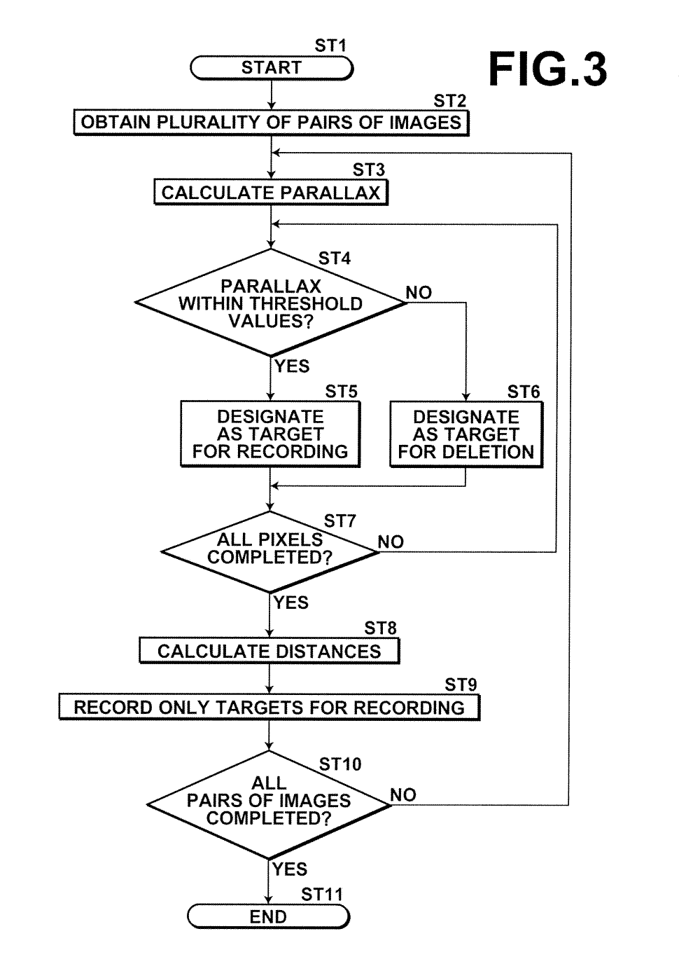

Next, the flow of a distance measuring process performed by the control device 20 will be described with reference to FIG. 3. First, the process is initiated at step ST1. The control device 20 obtains pairs of image data sets formed by image data output from the digital cameras 11A and 11B as they photograph the measurement target 14 at step ST2. The control device 20 controls the operation of the stereoscopic camera driving section 21 based on commands input via the interface (not shown) during image obtainment, such that the digital cameras 11A and 11B have a predetermined baseline therebetween during a first photography operation. Then, the digital camera 11A is moved for a predetermined distance, and a second photography operation is executed. Image data output from each of the digital cameras 11A and 11B are obtained for each photography operation, and therefore, two pairs of image data sets are obtained in the present example.

At step ST3, the control device 20 calculates the amounts of parallax for corresponding points within each pair of images employing the parallax calculating section 23 of FIG. 2, based on image data that represent the images within each pair. Note that searching for the corresponding points and calculating of the amounts of parallax maybe performed by known methods, such as those described in Japanese Unexamined Patent Publication Nos. 10(1998)-320561 and 2008-190868.

Next, the control device 20 performs the processes of steps ST4 through ST7, employing the recording judgment section 24 of FIG. 2. At step ST4, the recording judgment section 24 judges whether the amount of parallax for each pair of corresponding points (corresponding pixels) within each pair of images are between two predetermined threshold values, that is, within a predetermined range to be described later. In the case that the amount of parallax for a pair of corresponding points is within the predetermined range, the amount of parallax is judged to be a target for recording at step ST5. In the case that the amount of parallax for a pair of corresponding points falls outside the predetermined range, the amount of parallax is judged to be a target for deletion at step ST6. The judgment results are correlated with data that represents the amounts of parallax, and sent to the following processes. Next, the control device 20 judges whether the above judgment process has been completed for all of the pairs of corresponding pixels within the pairs of images at step ST7. In the case that the judgment process has not been completed, the process returns to step ST4, and in the case that the judgment process has been completed, the process proceeds to step ST8.

Next, the control device 20 performs the processes of steps ST8 through ST10, employing the distance calculating section 25 of FIG. 2. At step ST8, the distance calculating section 25 calculates the distance of each of the corresponding points, that is, the distance from the digital cameras 11A and 11B to each point on the surface of the photographed measurement target 14, based on the amounts of parallax of the corresponding points within each pair of images. Then, at step ST9, the control device 20 records data that represents distances which are obtained based on the amounts of parallax which were judged to be targets for recording at step ST5 in the recording section 26 of FIG. 2. Next, at step ST10, the control device 20 judges whether the distance calculating process has been completed for all pairs of images (two pairs in the present example). In the case that the distance calculating process has not been completed for all pairs of images, the process returns to step ST3, and in the case that the distance calculating process has been completed for all pairs of images, the process proceeds to step ST11 and ends.

Note that the data, which are recorded in the recording section 26 and represent the distances, are utilized to generate data representing the distances from the stereoscopic camera 10, that is, depth data, when obtaining three dimensional positional data regarding each point on the surface of the measurement target 14.

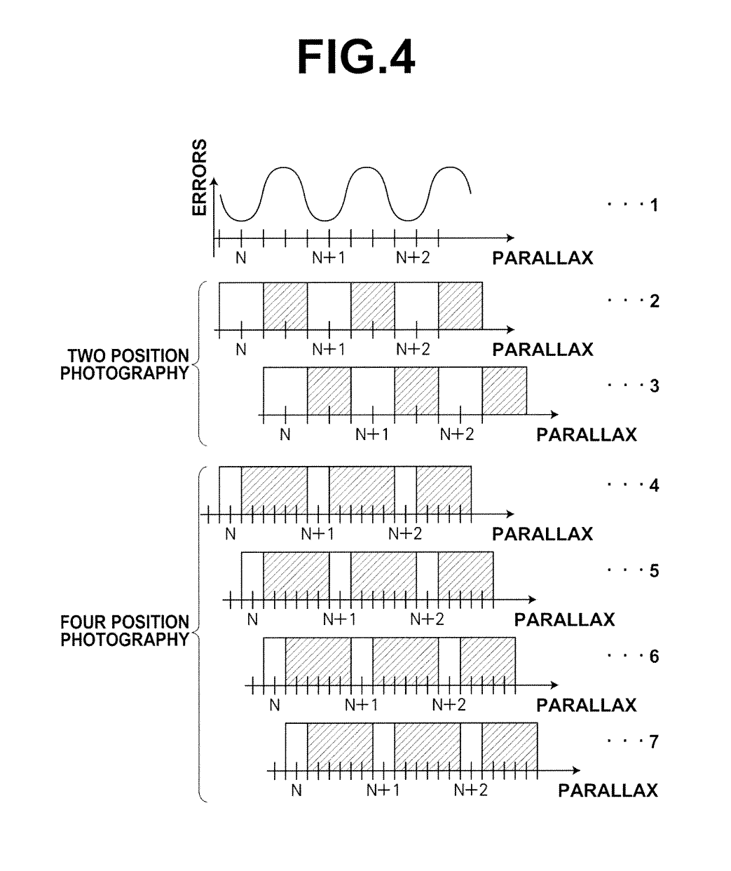

FIG. 4 is a collection of diagrams for explaining a process for extracting amounts of parallax to be extracted from among the data that represents the amounts of parallax obtained as described above. The graph indicated by the number 1 in FIG. 4 is a diagram that illustrates the relationships among calculated amounts of parallax and errors. Note that here, the amounts of parallax are represented as distances relative to distances on the imaging surfaces of the digital cameras 11A and 11B. More specifically, the amounts of parallax are represented as distances relative to the pixel pitch of imaging elements. N to N+1 and N+1 to N+2 corresponds to single pixel pitches.

As illustrated here, the errors vary basically periodically corresponding to the amount of parallax, and the period of variation is a single pixel pitch. Hereinafter, the pixel pitch will be referred to as “L”.

In order to employ amounts of parallax having small amounts of errors to calculate distances, first, N is designated to be a positive integer from an amount of parallax related to a pair of images obtained by the first photography operation (refer to the diagram indicated by the number 2 in FIG. 4), and amounts of parallax within a range from N−0.25L to N+0.25L are extracted, while the remaining amounts of parallax, that is, the amounts of parallax indicated by the hatched portions in the diagram indicated by the number 2 in FIG. 4, are deleted. This is the process executed in steps ST5 and ST6 of FIG. 3. The amounts of parallax extracted in this manner are those within ranges of ±0.25L of N, N+N+2 . . . , having those values as their centers, which are values having the smallest amounts of errors.

The diagram indicated by the number 3 in FIG. 4 illustrates amounts of parallax for a pair of images obtained by the second photography operation. Although not shown in FIG. 4, the error properties of these amounts of parallax are the same as those illustrated in the graph indicated by the number 1 in FIG. 4. That is, the errors in the amounts of parallax become minimal at N, N+1,N+2, and fluctuate periodically at periods equal to the pixel pitch. The processes of steps ST5 and ST6 of FIG. 3 are executed with respect to the amounts of parallax illustrated in the diagram indicated by the number 3 in FIG. 4 as well. That is, N is designated as a positive integer, amounts of parallax within a range from N−0.25L to N+0.25L are extracted, while the remaining amounts of parallax, that is, the amounts of parallax indicated by the hatched portions, are deleted. Note that in this case, the values N−0.25L and N+0.25L are the aforementioned threshold values.

Here, the baseline length is changed by L/2 between the first photography operation and the second photography operation. Therefore, the distances indicated by the ranges of the amounts of parallax which are extracted from the diagram indicated by the number 3 in FIG. 4 (the white rectangles) are the same as the distances indicated by the ranges of the amounts of parallax represented by the hatched portions of the diagram indicated by the number 2 in FIG. 4 directly above them. Conversely, the distances indicated by the ranges of the amounts of parallax which are extracted from the diagram indicated by the number 2 in FIG. 4 (the white rectangles) are the same as the distances indicated by the ranges of the amounts of parallax represented by the hatched portions of the diagram indicated by the number 3 in FIG. 4 directly beneath them.

By combining the amounts of parallax extracted from the diagram indicated by the number 2 in FIG. 4 and the amounts of parallax extracted from the diagram indicated by the number 3 in FIG. 4 so as to interpolate each other and calculating distance data based thereon, distance data having no gaps therein can be obtained. Alternatively, distance data may be obtained based on the amounts of parallax extracted from the diagram indicated by the number 2 in FIG. 4, distance data may be obtained based on the amounts of parallax extracted from the diagram indicated by the number 3 in FIG. 4, and the obtained distance data may be combined to interpolate each other.

Next, an alternate embodiment of the present invention will be described with reference to the diagrams indicated by numbers 4 through 7 in FIG. 4. In the embodiment described above, the value of m was set to 0 and the value of n was set to 2, such that the baseline length was reduced by L/2 after the first photography operation, and a total of two photography operations (photography from two positions) were performed. In contrast, in the alternate embodiment, the value of m is set to 0, and the value of n is set to 4. After a first photography operation is performed with an arbitrarily set baseline length, the baseline length is reduced by L/4, 2L/4, and 3L/4, to perform a total of four photography operations (photography from four positions) .

In this case, the amounts of parallax which are extracted and deleted from among the amounts of parallax obtained by the first, second, third, and fourth photography operations are the white rectangles and the hatched portions indicated in the diagrams indicated by numbers 4 through 7 in FIG. 4, respectively. In this case, the amounts of parallax within ranges of N−0.125L to N+0.125L are extracted.

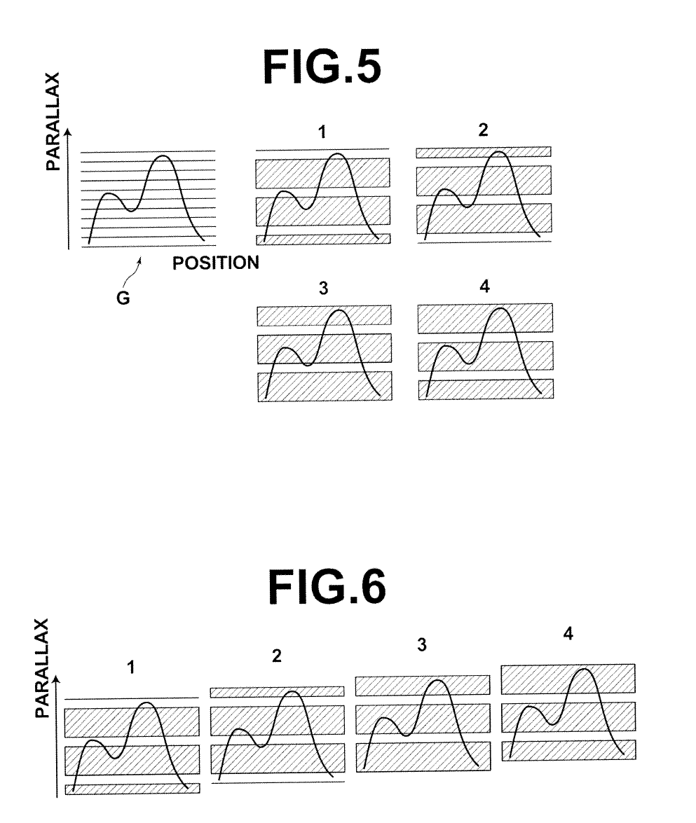

Hereinafter, the amounts of parallax which are extracted and deleted in the alternate embodiment will be described in greater detail. Parallax properties G as illustrated in the graph at the upper left of FIG. 5 will be considered, as an example. If such parallax properties are obtained in a total of four photography operations without varying the photography positions, and amounts of parallax are extracted and deleted as described above, the amounts of parallax which are deleted and extracted from among the amounts of parallax obtained during the first, second, third, and fourth photography operations will be those indicated by the hatched portions and the portions between the hatched portions illustrated in the diagrams indicated by numbers 1 through 4 in FIG. 5, respectively.

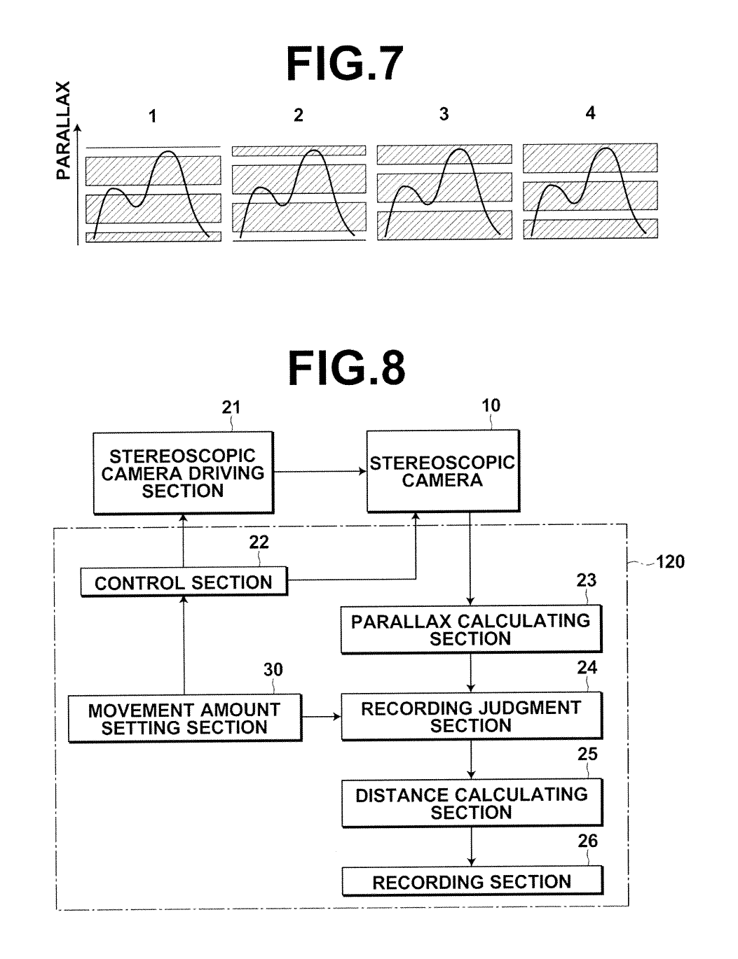

In the present embodiment, however, the four photography operations are performed from different positions. Therefore, the amounts of parallax which are deleted and extracted are those indicated by the hatched portions and the portions between the hatched portions illustrated in the diagrams indicated by numbers 1 through 4 in FIG. 6, respectively. In this case, if the ranges between the hatched portions are combined and distance data are obtained based on the combined amounts of parallax, errors will be generated in the distance data. In order to prevent such errors from being generated, a process that compensates for differences that occur due to differences in photography positions from that of the first photography operation may be administered to the amounts of parallax between the hatched portions of the diagrams indicated by numbers 2 through 4 in FIG. 6. Then, the processed amounts of parallax as illustrated in the diagrams indicated by numbers 2 through 4 in FIG. 7 may be combined.

Next, a distance measuring apparatus according to a second embodiment of the present invention will be described with reference to FIG. 8. Note that elements which are the same as those described with reference to FIG. 2 will be denoted with the same reference numerals, and redundant descriptions thereof will be omitted insofar as they are not particularly necessary (the same will be applied to subsequent embodiments).

The apparatus of the second embodiment enables selection of two position photography, four position photography, and the like. A control device 120 is provided with a movement amount setting section 30. The apparatus of the second embodiment differs from that illustrated in FIG. 2 basically only in this point.

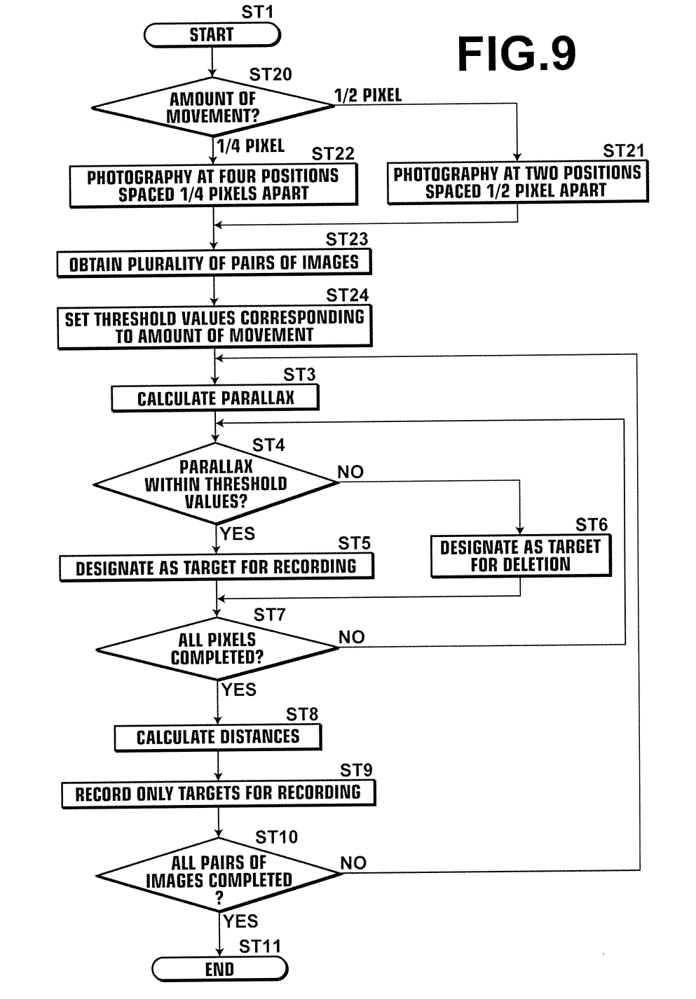

Next, the processes performed by the apparatus of the second embodiment will be described with reference to FIG. 9. First, the process is initiated at step ST1. The control device 120 judges the amount of movement for a single movement operation of the digital camera 11A, which is specified in the movement amount setting section 30 via the interface (not shown), at step ST20. In the case that the judgment result is a ½ pixel, that is, in the case that the value of n is 2, the process proceeds to step ST21. At step ST21, a first photography operation and a second photography operation, in which the digital camera 11A is moved to shorten the baseline length for a distance corresponding to ½ pixel, that is, L/2, are performed.

On the other hand, in the case that the judgment result at step ST20 is a ¼ pixel, that is, in the case that the value of n is 4, the process proceeds to step ST22. At step ST22, a first photography operation, in which the digital camera 11A is provided at an initial position, a second photography operation, in which the digital camera 11A is moved from the initial position to shorten the baseline length for a distance corresponding to ¼ pixel, that is, L/4, a third photography operation, in which the digital camera 11A is moved from the initial position to shorten the baseline length for a distance of 2L/4, and a fourth photography operation, in which the digital camera 11A is moved from the initial position to shorten the baseline length for a distance of 3L/4, are performed.

After the photography operations from two positions or from four positions are completed, the control device 120 obtains pairs of image data sets formed by image data output from the digital cameras 11A and 11B, at step ST23. Then, threshold values for extracting amounts of parallax are set, corresponding to the movement amounts of the digital camera 11A. The threshold values may be those described previously for photography from two positions and photography from four positions, for example. The process then proceeds to step ST3, which is the same as step ST3 of FIG. 3. The flow of processes thereafter is the same as those described with reference to FIG. 3.

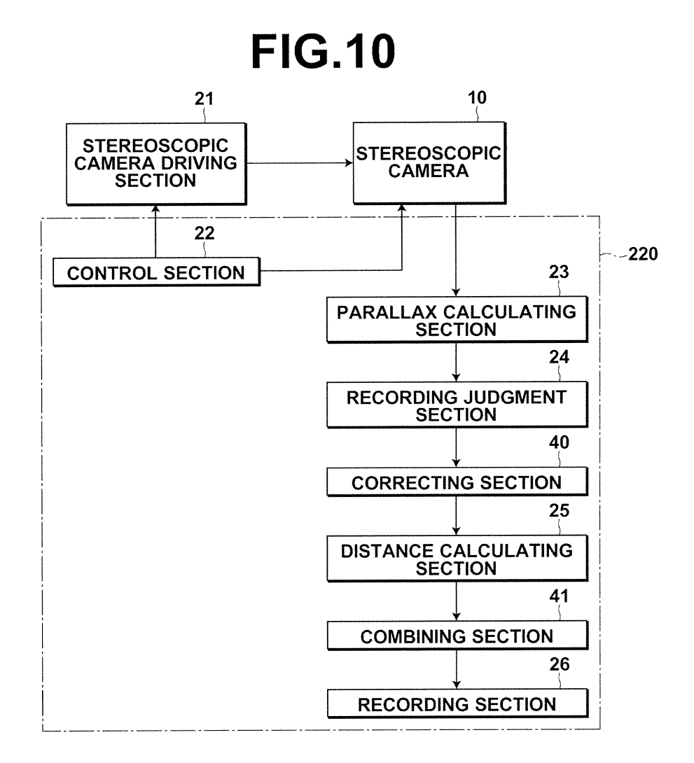

Next, a distance measuring apparatus according to a third embodiment of the present invention will be described with reference to FIG. 10. The apparatus of the third embodiment is capable of performing the correcting process that compensates for fluctuations in amounts of parallax due to differences in baseline lengths, which was described previously with reference to FIG. 7. A control apparatus 220 is provided with a parallax correcting section 40 that performs the correcting process. In addition, the apparatus of the third embodiment performs a process to combine distance data, which are calculated based on the corrected amounts of parallax. The control apparatus 220 is provided with a combining section 41 that performs the combining process. The apparatus of the third embodiment differs from that illustrated in FIG. 2 basically only in these points.

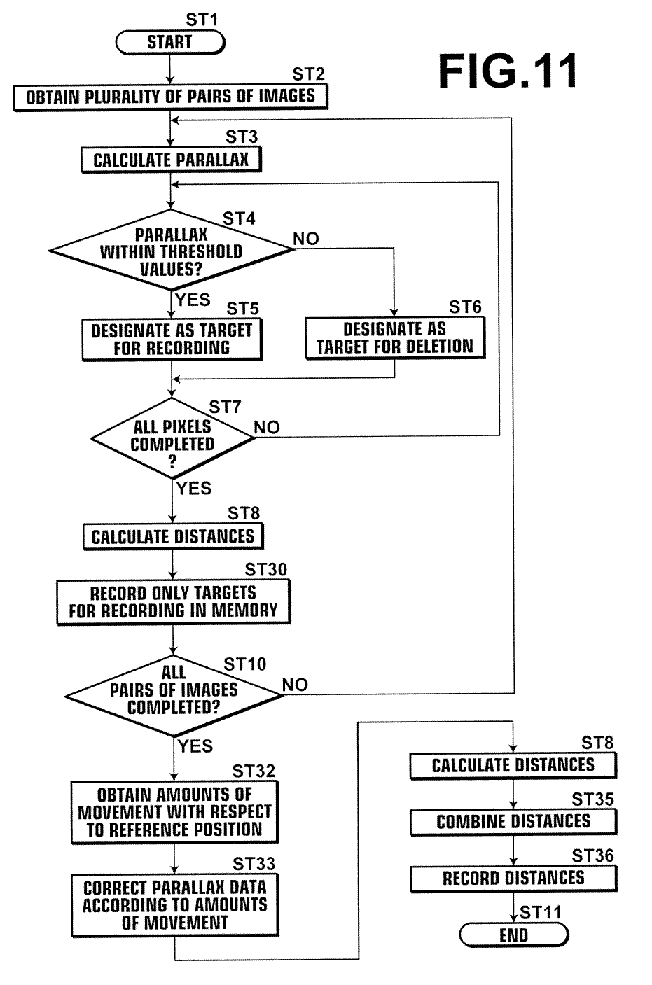

Next, the processes performed by the apparatus of the third embodiment will be described with reference to FIG. 11. The processes of steps ST1 through ST8 are the same as those described with reference to FIG. 3. When the process of step ST8 is completed, the control apparatus 220 records only the amounts of parallax which are targets for recording in a memory (not shown), at step ST30.

Next, at step ST10, the control device 220 judges whether the processes from step ST1 through ST30 have been completed for all pairs of images. In the case that the processes have not been completed for all pairs of images, the process returns to step ST3, and in the case that the processes have been completed for all pairs of images, the process proceeds to step ST32.

At step ST32, the control device 220 obtains data that represent amounts of movement of the digital camera 11A from a reference position (the position during the first photography operation) for the second and subsequent photography operations. In the case that the amounts of movement are specified by an operator via the interface or the like, the movement amount data are obtained form a memory or the like in which the data are stored. Next, at step ST33, the control device 220 corrects the amounts of parallax, which were obtained during each photography operation, were designated as targets for recording, and are stored in the memory, based on the obtained movement amount data. The correction process is the same as that described previously with reference to FIG. 6 and FIG. 7.

Thereafter, the control device 220 employs the distance calculating section 25 of FIG. 10 to calculate the distances of each corresponding point based on the corrected amounts of parallax at step ST8. Next, the control device 220 combines data that represents the distances at step ST35. The combining process is performed instead of process for combining the extracted amounts of parallax of the diagram indicated by the number 2 in FIG. 4 and the extracted amounts of parallax of the diagram indicated by the number 3 in FIG. 4, which was described previously. That is, distance data are obtained based on the amounts of parallax extracted from the diagram indicated by the number 2 in FIG. 4, distance data are obtained based on the amounts of parallax extracted from the diagram indicated by the number 3 in FIG. 4, and the obtained distance data are combined to interpolate each other.

Next, at step ST36, the control device 220 records the combined distance data in the recording section 26 of FIG. 10. The process ends at step ST11.

Embodiments in which the values of n were set as 2 and 4 have been described. However, the value of n is not limited to these values, and other positive integers having a value of 3 or greater may be applied. Further, the value of m was set as 0 in the embodiments described above. However, the value of m may be any integer having a value of 1 or greater.

1.-7. (canceled)

8. A distance measuring method, for obtaining distance data regarding corresponding points within pairs of images of a subject, which have been obtained by photographing the subject with two imaging sections provided with a predetermined baseline length therebetween, based on the amounts of parallax among the corresponding points, comprising:
performing a first photography operation with the baseline length set at an arbitrary value;
performing n photography operations after the first photography operation, while varying the baseline length by L(m+1/n), L(m+2/n) . . . L(m+(n−1)/n) at each photography operation, wherein L is a pixel pitch of the imaging means, m is an arbitrary natural number, and n is an integer greater than or equal to 2;
extracting amounts of parallax within a predetermined range common to each photography operation from among the amounts of parallax which are obtained by the n photography operations; and
obtaining the distance data based on the extracted amounts of parallax.

9. A distance measuring method as defined in claim 8, wherein:
one of the imaging sections is fixed when varying the baseline length.

10. A distance measuring method as defined in claim 8, wherein:
the extracted amounts of parallax are subject to a correcting process that compensates for variations due to the differences in baseline lengths; and
the distance data are obtained based on the processed amounts of parallax.

11. A distance measuring method as defined in claim 8, wherein:
the value of n is changed according to one of a desired distance output accuracy and a desired distance output speed.

12. A distance measuring method as defined in claim 9, wherein:
the extracted amounts of parallax are subject to a correcting process that compensates for variations due to the differences in baseline lengths; and
the distance data are obtained based on the processed amounts of parallax.

13. A distance measuring method as defined in claim 9, wherein:
the value of n is changed according to one of a desired distance output accuracy and a desired distance output speed.

14. A distance measuring method as defined in claim 10, wherein:
the value of n is changed according to one of a desired distance output accuracy and a desired distance output speed.

15. A distance measuring apparatus, comprising:
two imaging sections, which are provided with a predetermined baseline length therebetween;
a calculating section, for obtaining distance data regarding corresponding points within pairs of images of a subject, which have been obtained by photographing the subject with the two imaging sections, based on the amounts of parallax among the corresponding points; and
a moving section, for relatively moving the two imaging means so as to perform n photography operations while varying the baseline length by L(m+1/n), L(m+2/n) . . . L(m+(n−1)/n) at each photography operation, wherein L is a pixel pitch of the imaging means, m is an arbitrary natural number, and n is an integer greater than or equal to 2, after a first photography operation, during which the baseline length is set at an arbitrary value, is performed;
the calculating section being configured to extract amounts of parallax within a predetermined range common to each photography operation from among the amounts of parallax which are obtained by the n photography operations and to obtain the distance data based on the extracted amounts of parallax.

16. A distance measuring apparatus as defined in claim 15, wherein:
the moving section moves one of the two imaging means, while maintaining the other imaging means in a fixed state.

17. A distance measuring apparatus as defined in claim 15, further comprising:
a correcting section, for administering a correcting process that compensates for variations due to the differences in baseline lengths on the extracted amounts of parallax.

18. A distance measuring apparatus as defined in claim 16, further comprising:
a correcting section, for administering a correcting process that compensates for variations due to the differences in baseline lengths on the extracted amounts of parallax.
